(19) United States
(12) Patent Application Publication
(10) Pub. No.: US 2019/0321867 A1
(43) Pub. Date: Oct. 24, 2019

(54) CLEANING ARTICLE FOR USE WITH ELECTRONIC DEVICES

(71) Applicant: MICROSOFT TECHNOLOGY LICENSING, LLC, Redmond, WA (US)

(72) Inventor: Christopher Luke BATES, Kirkland, WA (US)

(73) Assignee: MICROSOFT TECHNOLOGY LICENSING, LLC, Redmond, WA (US)

(21) Appl. No.: 15/960,529

(22) Filed: Apr. 23, 2018

(51) Int. Cl. B08B 7/00; A47L 13/17; B08B 3/08; C11D 3/386; C11D 17/04; C11D 11/00

(52) U.S. Cl. CPC B08B 7/0014; A47L 13/17; B08B 7/0071; C11D 11/0017; C11D 3/386; C11D 17/04; B08B 3/08

(57) ABSTRACT

Electronic devices that include fabric surfaces can periodically require cleaning. Methods and tools for safely and reliably cleaning such surfaces are disclosed. The method includes application of a cleaning pad impregnated with a cleaning agent for a predetermined period of time. The cleaning pad is configured to remove stains and contaminants from the surface through a measured approach.

### BACKGROUND

There has been growing reliance on electronic devices, personal computers and other small devices. As a result, electronic devices are being used increasingly in environments that expose the devices to a wide range of contaminants. For example, various electronic devices, such as cell phones, smartphones, laptop computers, tablet computers, e-readers, computer keyboards, electronic displays, and the like, may become soiled with dust, dirt, germs, fingerprints, sweat, lotion, oils, spilled liquids, food, and other such contaminants. Components and surfaces associated with these devices tend to require periodic cleaning and sanitizing to maintain a satisfactory appearance, operating efficiency, as well as a general cleanliness.

In some cases, users may attempt to clean their device with cleaning agents that are fluid or liquid-based, via a spray bottle or a saturated sponge. In some other cases, users may wipe the device with a damp wipe, a cloth that has been soaked with cleaning fluid, or even apply fluid directly onto the device. However, because these cleaning techniques involve the relatively uncontrolled release or application of liquids to the surfaces of electronic devices, there is significant risk of damage to the device. Thus, there remain significant areas for new and improved ideas for the cleaning of electronic devices in a safe, effective, and convenient manner.

### SUMMARY

A cleaning tool for use with electronic devices, in accord with a first aspect of this disclosure, includes a carrier layer with an absorbent substrate, and a cleaning agent, where the cleaning agent is stored by or within the carrier layer. The cleaning tool also includes a backer layer disposed above the carrier layer, and a release liner, the release liner being disposed below the carrier layer. The cleaning agent is configured to clean a surface of an electronic device that includes a textile-based material. The cleaning tool further includes an activation area that is disposed between the release liner and the carrier layer. The activation area is configured to be removably affixed to a textile-based surface of an electronic device, thereby exposing the textile-based surface to the cleaning agent and cleaning the textile-based surface and/or removing contaminants from the textile-based surface.

A method of cleaning an electronic device, in accord with a second aspect, includes peeling a release liner away from a lower surface of a cleaning pad, and aligning the cleaning pad with a soiled region of the electronic device. The method also includes applying the cleaning pad to a portion of a surface of the electronic device that corresponds to the soiled region, the soiled region including a first textile material. In addition, the method includes peeling the cleaning pad away from the electronic device, thereby transitioning the soiled region to a cleansed region that is substantially free of contaminants.

In accord with another aspect of this disclosure, a kit of parts for cleaning electronic devices includes a first cleaning pad. The first cleaning pad includes a carrier layer and a cleaning agent, where the cleaning agent is stored by the carrier layer, and the cleaning agent is configured to clean a surface of an electronic device that includes a first type of textile material.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example of a system and method for cleaning an electronic device using a cleaning pad;

FIG. 2 is an isometric view of an implementation of a cleaning pad including an enlarged cross-sectional view;

FIG. 3 is an isometric exploded view of an implementation of the cleaning pad;

FIGS. 4A-4D illustrate an implementation of a method of cleaning an electronic device;

FIG. 5 is a flow chart presenting an implementation of a method of cleaning an electronic device;

FIGS. 6A-6D depict implementations of different types of cleaning pads;

FIG. 7 is an implementation of a cleaning pad that includes a thermal activation layer;

FIGS. 8A and 8B illustrate an implementation of a cleaning pad that includes imagery and text; and

FIG. 9 is an illustration of an implementation of a retail display in which various kits with a variety of cleaning pads are shown.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. In the following material, indications of direction, such as “top” or “left,” are merely to provide a frame of reference during the following discussion, and are not intended to indicate a required, desired, or intended orientation of the described articles.

The following description presents various implementations of cleaning tools for use with electronic devices, as well as methods for cleaning electronic devices. The methods include the application of a cleaning pad impregnated with a cleaning agent onto the surface of an electronic device for a predetermined period of time. The cleaning pad is configured to remove stains and contaminants from the surface through a measured approach, reducing the likelihood of damage to the device. Consumers may also select cleaning pads specifically designed for their brand of electronic device, or the type of stain being removed.

For purposes of this description, an electronic device includes any machine, tool, instrument, apparatus, and/or component that is associated with or includes provisions for adjusting the flow of electrical currents. For example, an electronic device can be used to convert electrical energy into heat, light, or motion, as well as manipulate electrical current to perform, produce, receive, and/or transmit various types of information, such as images, text or data, or sound. Some examples of electronic devices include consumer electronics such as televisions, gaming systems, robotic devices, telephones, mobile phones, desktops, monitors, keyboards, cameras, laptops, tablets, computer accessories, digital displays, printers, among other examples.

Electronic devices such as tablets, computers, keyboards, and other smart devices have been increasingly moving toward a consumer-centric experience. As electronic devices become more ubiquitous, users are drawn to products that provide a more comfortable experience with respect to their use of technology. Such ‘domestication’ of technology has led to the manufacture of devices that include not just functional applications, but also features directed to aesthetics and comfort. In some cases, fabrics and textiles such as cloth, leather, or synthetic materials are used to augment the user experience.

A variety of commercial products are at least partially formed from textiles or animal products. As examples, articles of apparel (e.g., shirts, pants, socks, jackets, undergarments, footwear), containers (e.g., backpacks, bags), and upholstery for furniture (e.g., chairs, couches, car seats) are often formed from various textile elements that are joined through stitching or adhesive bonding. Textiles may also be utilized in bed coverings (e.g., sheets, blankets), table coverings, towels, flags, tents, sails, and parachutes. Textiles utilized for industrial purposes are commonly referred to as technical textiles and may include structures for automotive and aerospace applications, filter materials, medical textiles (e.g. bandages, swabs, implants), geotextiles for reinforcing embankments, agrotextiles for crop protection, and industrial apparel that protects or insulates against heat and radiation. Accordingly, textiles may be incorporated into a variety of products for both personal and industrial purposes. As described herein, such textiles as well as other fabric materials are also being more commonly incorporated into electronic devices.

Textiles may be defined as any manufacture from fibers, filaments, or yarns having a generally two-dimensional structure (i.e., a length and a width that are substantially greater than a thickness). Furthermore, for purposes of this application, textiles will incorporate any animal-based materials used as fabrics (e.g., leather, suede). In general, textiles may be classified as mechanically-manipulated textiles or non-woven textiles. Mechanically manipulated textiles are often formed by weaving or interlooping (e.g., knitting) a yarn or a plurality of yarns, usually through a mechanical process involving looms or knitting machines. Non-woven textiles are webs or mats of filaments that are bonded, fused, interlocked, or otherwise joined. As an example, a non-woven textile may be formed by randomly depositing a plurality of polymer filaments upon a surface, such as a moving conveyor. Various embossing or calendaring processes may also be utilized to ensure that the non-woven textile has a substantially constant thickness, impart texture to one or both surfaces of the non-woven textile, or further bond or fuse filaments within the non-woven textile to each other. Whereas spunbonded non-woven textiles are formed from filaments having a cross-sectional thickness of 10 to 100 microns, meltblown non-woven textiles are formed from filaments having a cross-sectional thickness of less than 10 microns.

Although some products are formed from one type of textile, many products may also be formed from two or more types of textiles in order to impart different properties to different areas. As an example, a palm-rest of a keyboard may be formed from a textile that imparts durability (e.g., abrasion-resistance) and comfort, whereas other areas may be formed from a textile that imparts moisture-absorption. In another example, an electronic device may include various types of textiles or other materials (e.g., polymer foam, leather, synthetic leather), and some of the layers may also have areas formed from different types of plastics or relatively rigid materials that can impart different properties to the device.

Fabrics, textiles, and animal-based materials are generally flexible, conformable, soft to the touch, and can be extended across large or small surface areas of a device. As one example, the Microsoft® Surface series of products including touchscreen personal computers, tablets, keyboards, interactive whiteboards, and other accessories have incorporated textiles along various portions of their devices. In some cases, a high-end microfiber that resists stretch, bubble, or shrinkage across a wide range of temperatures such as Alcantara has been used to cover portions of keyboards and tablets. In some implementations, the material used on a device can be coated with a layer of polyurethane to reduce the likelihood of stains on the fabric without substantially altering the feel of the fabric.

Additional details regarding some features of this material are presented in U.S. Patent Application Publication 2017/0293321 by Rosen et al., entitled “Non-woven material device covering”, published on Oct. 12, 2017, which is herein incorporated by reference in its entirety. However, it should be understood that the implementations of the cleaning pad and method of cleaning described herein can be utilized across a wide variety of textiles incorporated into any electronic device, including but not limited to textiles formed of animal products (such as wool or silk), plant products (such as cotton, flax, jute), mineral products (such as asbestos or glass fibers), and synthetic products (such as nylon, polyester, or acrylic). These materials are recited for purposes of illustration only, and other types of materials may also be cleaned effectively by the cleaning pads described herein.

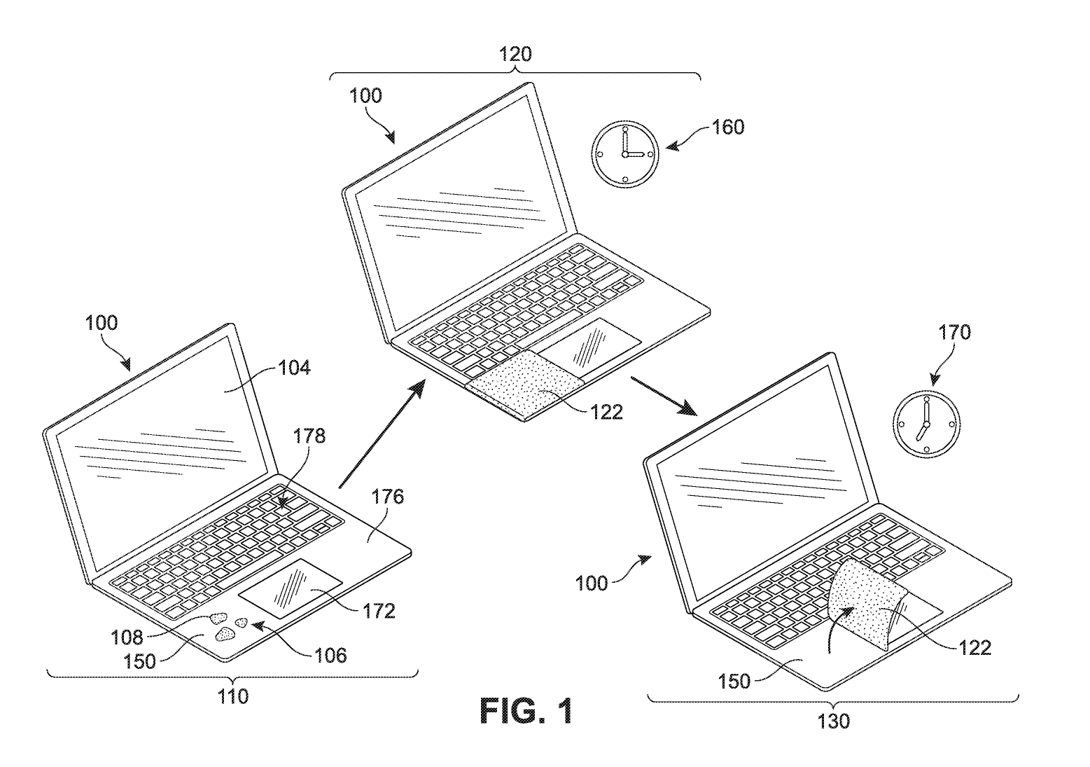

As a general overview, FIG. 1 presents one implementation of a system and method of cleaning an electronic device. In FIG. 1, a first electronic device (“first device”) 100 is depicted across a sequence of three drawings. For purposes of illustration in this case, the first device 100 is a type of laptop or tablet computer, and includes an input component (here including a track pad 172, a left palm-rest 174 and right palm-rest 176, and a keypad or keyboard 178) attached to a display component (“display”) 104. Furthermore, a textile material is arranged or otherwise included along an outer surface of the device such that it substantially covers and/or surrounds a portion of the first device 100 (here, the keys and trackpad of the first device 100 are surrounded by a fabric). The textile material may also be referred to as an outer material of the device. In a first step 110, the first device 100 is shown as including a soiled region 106 associated with a portion of the outer material, where the soiled region 106 includes some type of contaminant 108 that is external to the first device 100 and/or is otherwise undesired. In a second step 120, an article in the form of a cleaning tool (here a cleaning pad 122) has been applied to the soiled region 106. The placement of the cleaning pad or sheet on the surface of the electronic device, with the application of downward force (in the Z-direction), can provide highly effective spot and stain removal, as will be discussed in further detail below.

In a third step 130, the cleaning pad 122 is removed, revealing a cleansed region 150, where the cleansed region 150 is a region of the first device 100 that has been exposed to an activation area of the cleaning pad 122. The activation area refers to the portion of the cleaning pad 122 that is configured to contact contaminants of the soiled region and undergo a reaction that loosens and/or removes the contaminants. It can be understood that the activation area is the surface disposed between the release liner and the carrier layer. Once the release liner is peeled away or removed, the activation area becomes exposed to the external environment. The activation area corresponds to the side or surface of the cleaning pad that is then pressed onto or directly contacts the textile surface of the electronic device. Thus, the activation area can be understood to refer to the lower side of the carrier layer (i.e., the side opposite to the side with a backer layer).

When a cleaning pad is removably affixed to a targeted portion of a surface of an electronic device that includes a textile-based material, the activation area will come into direct contact with the textile surface. As a result, the textile material receives, makes contact with, and/or is exposed to the cleaning agent that is stored in the cleaning pad and, over a period of time, the cleaning pad functions to remove contaminants from the textile surface. For purposes of this disclosure, the term “removably affixed” refers to the capacity of the cleaning tool to be securely adhered, attached, stuck, pressed, and/or fastened onto a textile surface, as well as be readily removed from the same surface with minimal effort and/or residue.

In this example, the cleansed region 150 shown in the third step 130 should be understood to correspond to the soiled region 106 illustrated in the first step 110. As shown in the third step 130, the contaminant or spill has been successfully removed from the device. Thus, in some implementations, the cleaning pad 122 can be understood to include a type of adhesive sheet or substance that can allow the cleaning pad to be affixed onto a surface, and over time apply cleaning agent(s) onto the surface of the device and/or enable cleaning agents to soak into the thickness of the material comprising the surface of the device. In another implementation, the cleaning pad may be configured to absorb the contaminants into the pad substrate. The pad can then be removed and disposed.

For purposes of reference, between the second step 120 showing the application of the cleaning pad 122 and the third step 130 showing the removal of the cleaning pad 122, a first clock 160 is included as a representation of a start time (associated with the initial application of the cleaning pad) and a second clock 170 is included to represent an end time (associated with a removal of the cleaning pad). In different implementations, the period of time needed for effective cleaning of a soiled region can vary widely, depending on the type of textile material, the contaminant(s), the time that has passed since the soiling occurred, the amount of contaminant(s), the temperature, and other such factors.

In some implementations, the time required can range between one minute and 24 hours. In one implementation, the time period is, at a minimum, approximately 12 hours. In some cases, the cleaning pad should be applied and left overnight. It should be understood that the implementations described herein are safe for use on fabrics. Thus, leaving the cleaning pad on a device for extended periods (for example, days or weeks) would not result in adverse effects on the device's appearance or operation. In some cases, information and/or usage instructions may be provided with the cleaning pad that indicate the required time as related to the different factors described above and allow a user to optimize the cleaning experience. Furthermore, in some cases, the method may include an additional step of wiping the cleansed region or any remaining residue with an isopropyl alcohol (ISA) wipe or a microfiber cloth. In one implementation, the ISA wipe is approximately 70-99% IPA.

As will be discussed below, the use of the cleaning pads presented herein can provide significant advantages and protections for the maintenance of electronic devices. Traditionally, consumers have turned to standard liquid-based cleaning products for removing stains or restoring a device to a sanitary, hygienic, and/or clean state. Thus, upon encountering undesired damage or contaminant on a device, a consumer may pour or otherwise dispense cleaning and/or sanitizing fluids onto the soiled portion of the device. This approach can compromise the integrity of the electronic device, as there is no reliable means of limiting the areas covered or contacted by the liquid. Even in cases where a wipe is used, the damp surface of the agent can harm or affect the performance of an electrical device, or may be ineffective. This is particularly true when a consumer attempts to clean a device with a fluid and unintentionally introduces the fluid into areas of the device susceptible to damage. Other methods of cleaning surfaces often have no reliable means of controlling the amount of cleaning fluid used to clean a surface or ensuring a uniform application.

The implementations described herein offer several advantages over existing methods and systems used to clean or sanitize device surfaces. As a first example, the cleaning pads offer a relatively small, disposable, all-in-one cleaning solution. No further supplies are needed to clean the device, such as tissue or paper towels, wipes, spray bottles, or other cleaning supplies. A consumer can easily carry around the compact, lightweight implementations of the cleaning pad in his or her pocket, backpack, purse, laptop bag, or store it in a small drawer or cabinet. Accordingly, users of the cleaning pad are provided with a simple, straightforward solution for cleaning fabric materials that may surround or be disposed adjacent to sensitive electrical or mechanical components, as well as for textile materials generally. Some implementations are configured to contain, confine, restrict, or otherwise limit the cleaning agent to a specific area that is directly in contact with a lower surface of the cleaning pad and provide substantially uniform coverage across the corresponding surface area of the textile that comes into contact with the lower surface.

In some implementations, the cleaning pad may be reusable, allowing a user to clean a variety of surfaces over multiple occasions, while in other implementations, the pad may be designed as a single-use disposable tool. In addition, the application of a cleaning pad ensures a substantially consistent, uniform application of cleaning agent to the textile, rather than ‘spotty’ or uneven applications that may lead to inefficient or incomplete stain removal, or soaking of the fabric with chemicals. Furthermore, because the application entails a simple and direct affixation of the pad onto a surface, with no additional steps such as rubbing, wiping, or scrubbing with the pad, there is minimal risk of a consumer misusing the pad, or causing fraying, wear and tear, or damage to the textile surface.

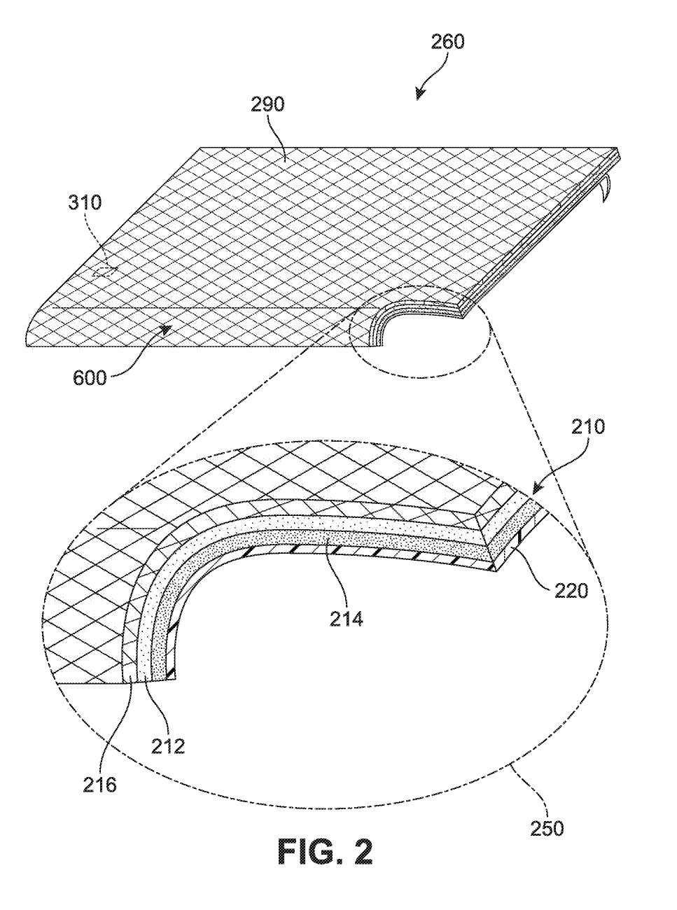

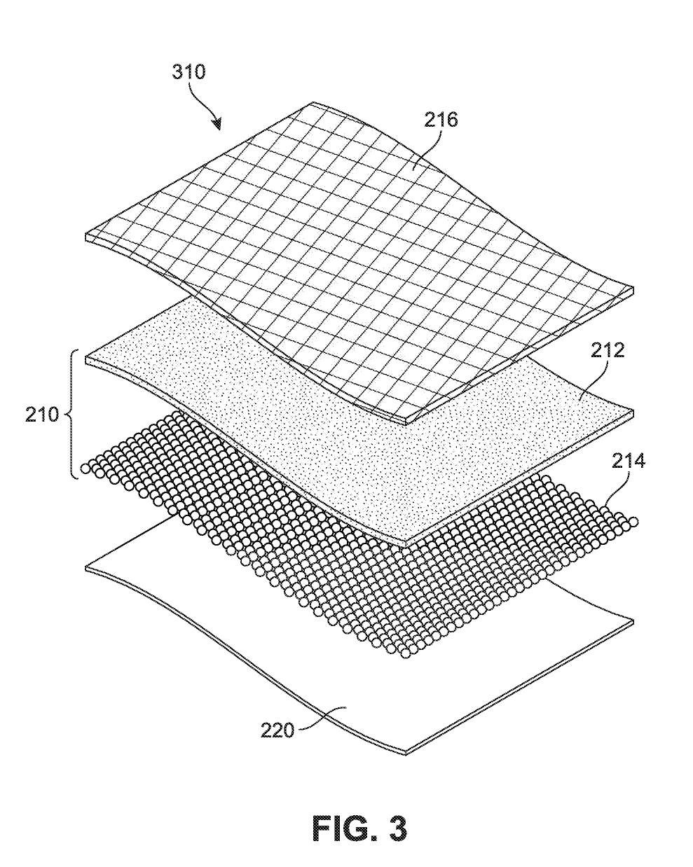

FIGS. 2 and 3 illustrate additional details regarding an implementation of the cleaning pad. In FIG. 2, an isometric view of a first pad 260 is shown with a magnified view 250 to better illustrate the various layers of the pad. FIG. 3 provides an exploded view of an implementation of a sample portion 310 of the first pad 260. In FIG. 2, the pad includes a first portion 210 and an optional second portion 220. In one implementation, the first portion 210 can include a carrier layer (“carrier”) 212 that is impregnated with a cleaning agent formulation. Solely for purposes of reference, the cleaning agent will be identified in the drawings as a cleaning substance layer (“cleaning agent”) 214. Together, the carrier layer 212 and the cleaning agent 214 forming a substantially uniform ‘primary’ layer. For purposes of this application, impregnation refers to the penetration or absorption of a chemical formulation into an assembly of fibers.

The carrier layer 212 can be understood to include an absorbent substrate that holds, stores, retains, includes, carries, contains, or is otherwise associated with the cleaning agent. Although the carrier layer 212 and the cleaning agent 214 are shown as two discrete layers in FIG. 2, it should be understood that this segmentation is for purposes of illustration only, and that the cleaning agent may be integrated or incorporated within the carrier such that the two form a substantially single or unitary layer or structure.

In some implementations, the carrier can be integrally manufactured or formed with the cleaning agent, while in other implementations, the cleaning agent 214 can be added, attached, sprayed, dissolved, inserted, or otherwise secured to or within the carrier 212 after manufacture of the carrier. In different implementations, the cleaning agent may be added to a dispenser material that is formed, disposed, included or incorporated in the carrier. The dispenser material can be configured to help dispense the cleaning agent at a predetermined flow rate following the application of mechanical pressure. For example, the dispenser material can be associated with an inherent resistance to fluid flow, such as through a known porosity or density of the dispenser material. Dispenser materials with different fluid flow characteristics may be used to tailor the cleaning pad.

In addition, in some implementations, the first portion 210 can include a sticky material or other adhesive substance associated with a lower surface of the first portion 210 that can facilitate the secure positioning of the cleaning pad on the device. However, in other implementations, the cleaning agent and carrier layer can themselves provide the friction or fastening mechanism necessary to securely apply or affix the cleaning pad to the device for the period of time required. Thus, the cleaning pad may be affixed and remain substantially stationary on the surface of the device until removal.

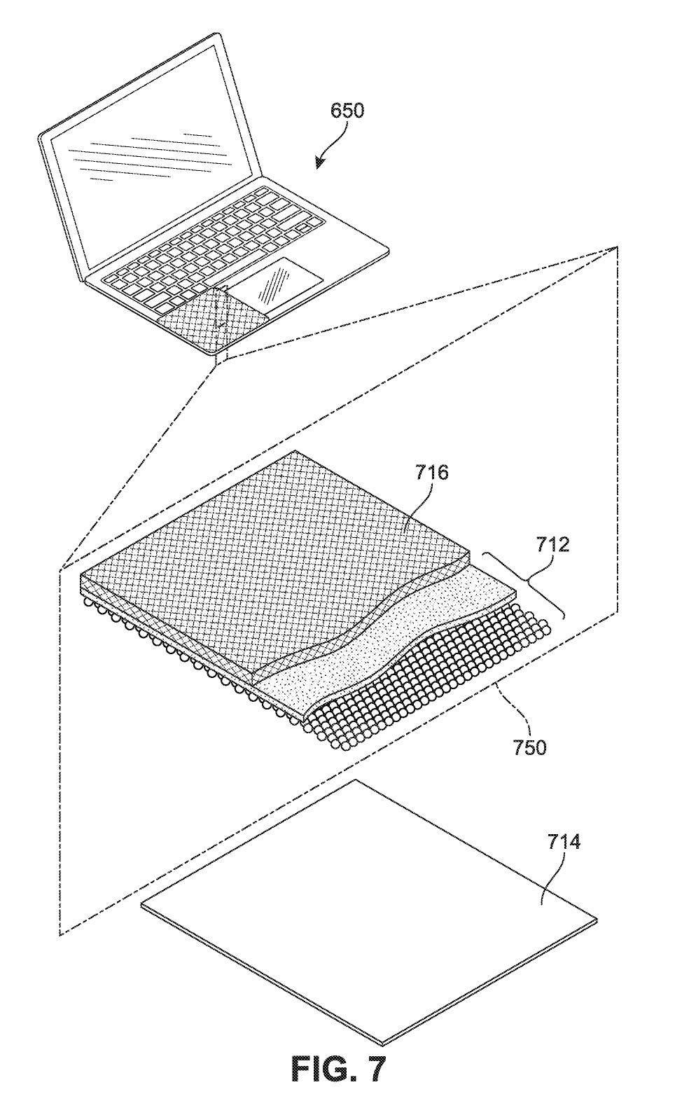

Furthermore, in some implementations, an upwardly-facing side 290 of the first portion 210 can include a backer layer 216. The backer layer 216 is disposed above the carrier layer 212, and can provide the stability, rigidity, support, and/or structural frame for the carrier layer that holds the cleaning agent. The backer can be associated with a variety of thicknesses and can usually be printed on, as will be discussed below with respect to FIGS. 7A and 7B. The structural backer can include but is not limited to paper, vinyl, polys (for example, polypropylene, polyester, Bi-Oriented Polypropylene (BOPP)), foil, static cling or sticks, cast vinyl or cut vinyl, destructible vinyl, coating, and/or lamination.

Furthermore, in some implementations, the pad may also include the second portion 220, comprising a release liner or a type of back-liner that has a slit backer or crack and peel function. In one implementation, the second portion 220 can comprise a removable cover that at least partially encapsulates, rests against, contacts, or surrounds a surface or side of the first portion 210. This can allow the cleaning pad to be easily transported or stored with minimal risk of the cleaning agent leaking onto other items or prematurely sticking or activating the cleaning agent. Such a cover may additionally provide an air-tight or water-tight (or at least partially air-tight or water-tight) seal to help limit or reduce the likelihood of any loss of fluid while not using the cleaning device, such as through evaporation or leakage. The liner may additionally help to keep contaminants away from the active portion of the cleaning pad until the pad is ready for use.

Throughout this disclosure, reference will be made to directions or axes that are relative to the cleaning pad's intended orientation with regards to an electronic device. For example, the term “distal” refers to a part that is located further from a center of a cleaning pad (toward the exterior) or a particular layer of the pad, while the term “proximal” refers to a part that is located closer to the center of the cleaning pad (toward the interior) or a particular layer of the pad. Thus, in FIG. 2, the carrier layer is disposed proximal relative to the backer layer. Similarly, the release liner is distal relative to the cleaning agent. In other words, the cleaning agent may be sandwiched between the carrier and the release liner in some cases. This is better illustrated in the exploded view of FIG. 3. In addition, use of the terms above, upper, below, lower, and other directional terms are made with reference to the cleaning pad as oriented for application on a device. Thus, in general, the cleaning agent will be disposed along a lower side of the first portion that is facing the device surface, while the backer layer will be disposed along an upper side of the first portion, facing away from the device.

As shown in FIG. 3, the cleaning pad includes the carrier layer 212, cleaning agent layer 214, and release layer (second portion 220). The cleaning agent 214 can include a formulation or composition of a plurality of ingredients, represented schematically here by a series of globular or spherical shapes. It should be understood that the representation of FIG. 3 is provided solely for purposes of illustration. Furthermore, in different implementations, the cleaning agent(s) used in the pad may vary depending on the material of the device for which the cleaning pad is designed, the contaminant being removed, and/or the preferences of the consumer. For example, alcohol or synthetic non-alcohol based cleaning agents that may include alcohol and one or more dilutants (such as water) can be incorporated into the pad. Alcohol-based cleaning substances may be advantageous for use with electronics, because excess fluid evaporates relatively quickly.

In some implementations, the pad can include scents and/or other additives as desired to enhance the appeal of the product and results. In some cases, the cleaning agent can be antibacterial, and/or can include a cleaning agent configured to remove streaks, smudges, fingerprints, or other undesirable marks. Some implementations may include a foaming agent, fluid and/or other substance designed to help control a flow of the cleaning agent from the pad onto the device. In some implementations, the cleaning agent includes one or more other additives, components and/or substances, such as, for example, antibacterial substances, and/or substances configured to leave an anti-glare or anti-fingerprint coating on the surface, or other such additives. For example, the cleaning agent(s) can include chloroxylenol, designed to kill bacteria and viruses.

In some implementations, the cleaning agents can include a plurality of surface-active agents (also referred to as surfactants), or molecules that contain a hydrophilic, or “water-loving” end, and a hydrophobic, or “water-fearing” end. When dirt or grease or other contaminants are present, surfactants can surround the contaminants until they are loosened or dislodged from the soiled surface, providing an effective means of penetrating, loosening and trapping particles, thereby cleaning the surface. Furthermore, in different implementations, the cleaning agent can include a variety of protein enzymes configured to catalyze chemical reactions and break down proteins in stains and dirt. It should be understood that in different implementations, the activities of the enzymes utilized can be highly specific to the types of substrates they can work on.

The cleaning agent(s) can include one or more classes of enzymes such as proteases, amylases, lipase, cellulases, mannanases, and pectinases. Each type may have many variations of the same protein structure that results in different preferences for conditions for peak performance. For example, it has been found to be beneficial to combine different enzyme types to improve overall stain-fighting performance. Therefore, the cleaning agent(s) that may be used can contain several enzyme class types to ensure optimal cleaning of complex soil substrates. The formulation may also include stabilization systems for liquid-based agents. Thus, the enzyme formulation can be designed for its effect on particular stains or surfaces.

In one example, the formulation may include a sporicidin protein designed to attack mold and mildew. One benefit of an enzymatic cleaner for mold is its recurring effect. Once the enzymatic cleaner attacks the mold and removes the contaminant, the enzymatic cleaner can remain on the surface and attack any new mold that occurs. Other cleaning agents include formulations with baking soda, tea tree oil, Borax, vinegar, grapefruit or salt, as well as therapeutic-grade essential oils. Because one enzyme molecule can act on many substrate molecules (such as soils and stains), a small amount of enzyme provided in the cleaning pad can provide a significant cleaning benefit to the consumer. In addition, enzymes generally are associated with a safe toxicological profile, lending to their sustainability profile. Furthermore, enzymes are not mutagenic nor are they clastogenic. They are also not reproductive or developmental toxins and have a low toxicity to aquatic systems, and are stable at moderate pH and temperatures.

In one particular implementation, the cleaning agent can include one or more of water, Sodium Lauryl Sulfate, C9-11 Pareth-8, PPG-26, Sodium Laureth Sulfate, Lauramine Oxide, Alcohol, Sodium Chloride, Tetrasodium Dicarboxymethyl Glutamate, Sodium Hydroxide, Phenoxyethanol, and/or Methylisothiazolinone.

Generally, implementations of the cleaning pads may include cleaning agents that minimize the risk of leaving visible residues on fabric surfaces, or only leave residues that are simple and easy to wipe off. In some implementations, the cleaning agents can be substantially free of various polyacrylate-based emulsifiers, polymeric anti-static agents, inorganic builder salts and other residue-forming materials, or include such compositions at low levels. The cleaning agent may also be configured for safe use on a wide range of textiles, including cotton and cotton/polyester blend fabrics, wool, silk, rayon, rayon acetate, velvet, suede, and suede-like materials. In addition, the cleaning agent composition may include ingredients formulated to minimize dye removal or migration from the stain site of dye from the fabrics being cleaned.

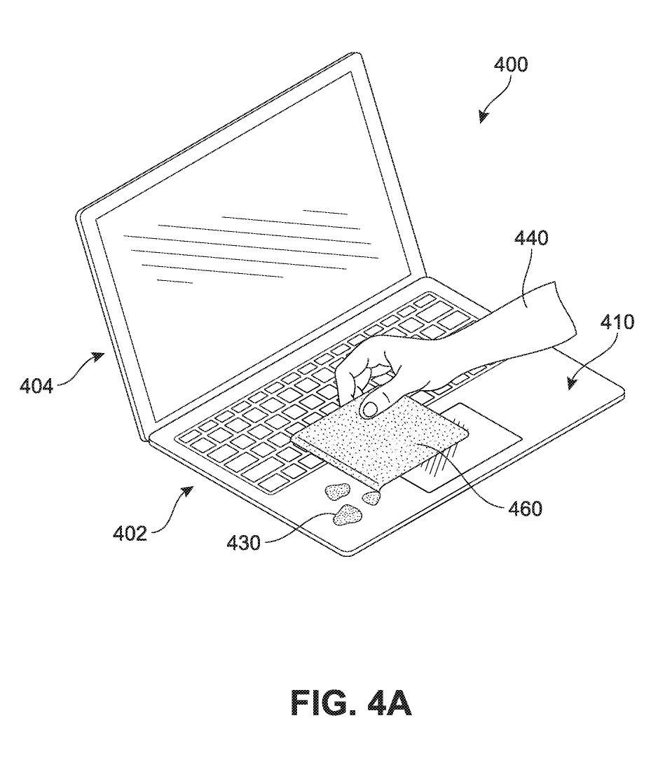

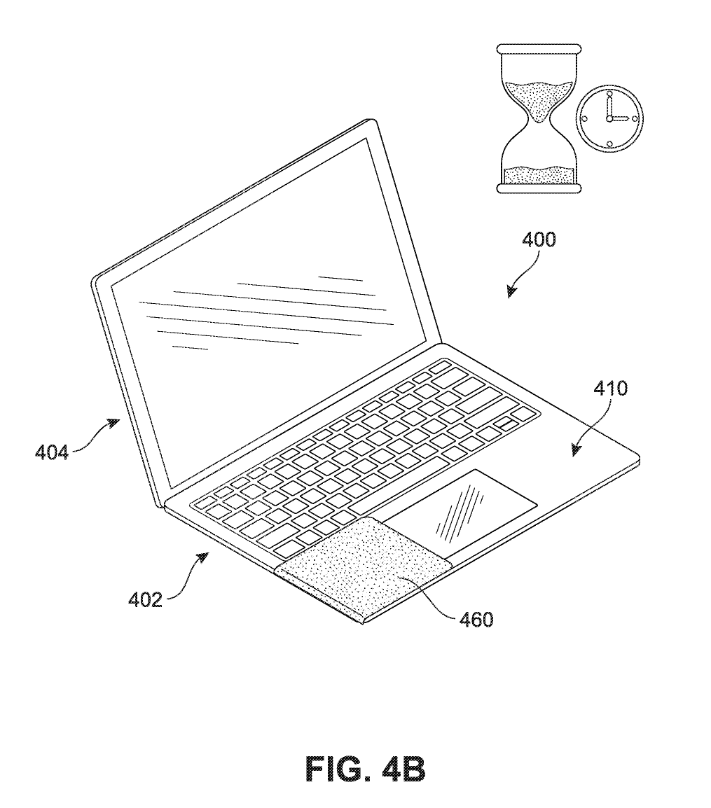

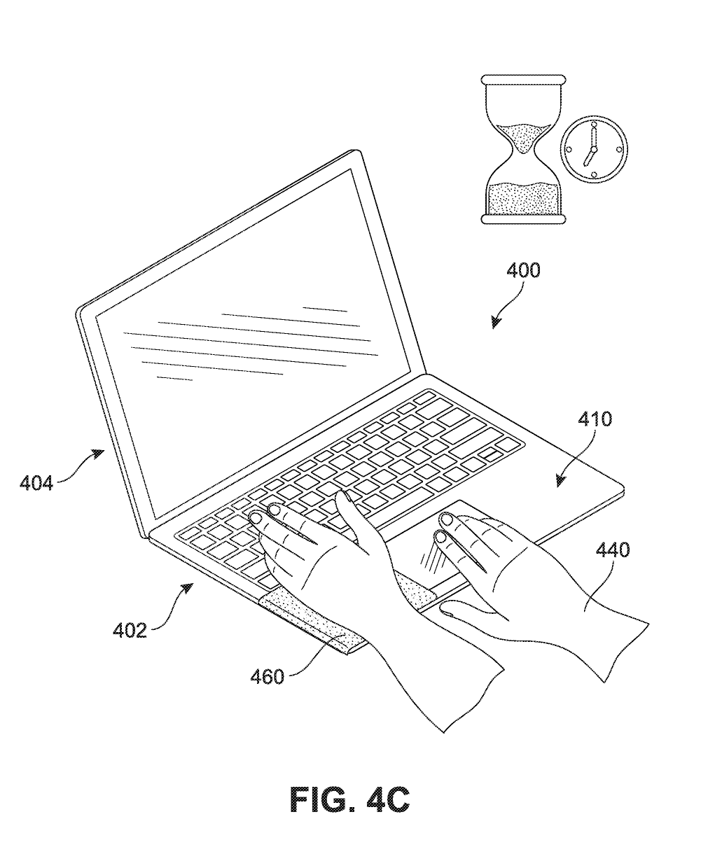

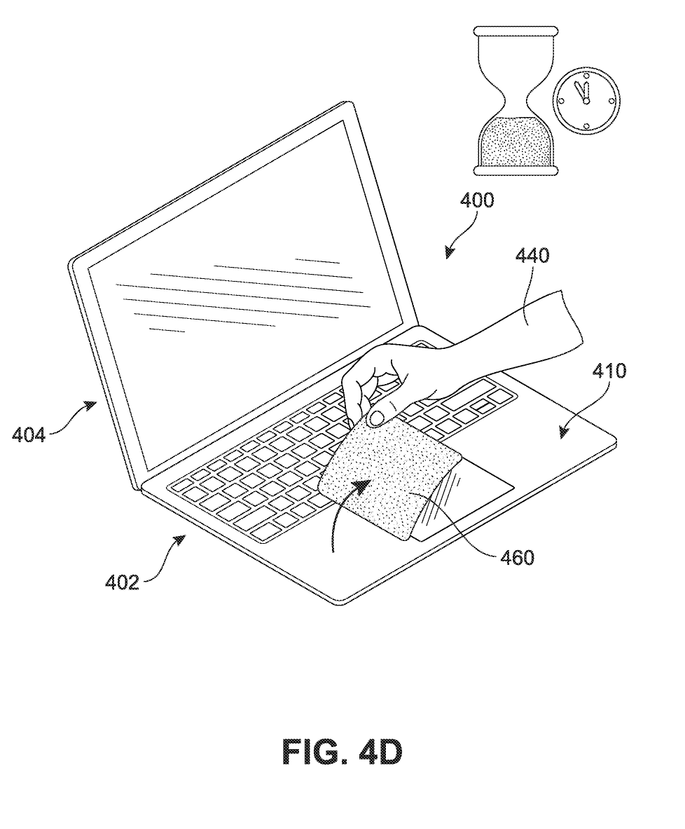

Additional details regarding the method of cleaning an electronic device are now provided with respect to FIGS. 4A-4D. In FIG. 4A, a second electronic device (“second device”) 400 is shown with a keyboard 402 and display 404. The keyboard includes an outer covering textile material (“outer material”) 410. The outer material 410 includes a soiled region 420 in which a plurality of stains or contaminants 430 have been deposited or formed. A user (represented by a hand 440) is shown in the process of applying or affixing a second pad 460. It should be understood that in some implementations, the stage shown in FIG. 4A may be preceded by the removal and/or dispensing of the outer release liner (see FIG. 2).

In FIG. 4B, the second pad 460 has been applied or otherwise disposed upon a portion of the device corresponding to the soiled region. During the period of time when the cleaning pad is affixed (schematically represented by an hourglass across FIGS. 4B-4D), the device may be left alone or—as shown in FIG. 4C—may be used in the normal or ordinary way. In other words, in some implementations, the device can continue to operate and be utilized by a consumer during the period of time in which the soiled region is being actively cleaned or exposed to the cleaning agent. As the pad is left or disposed on the surface of the device, the cleaning agent in the pad can be released and/or can absorb the contaminants. The cleaning thus occurs in a discrete, contained area, with minimal risk of runoff of cleaning fluids to any other portion of the device.

Furthermore, the mechanism by which the cleaning occurs may be understood to result at least in part from the mechanical pressure or contact between a downwardly-facing outer surface 470 of the pad and the soiled region. As pressure is applied the cleaning agent can be transmitted, released, or deposited onto the textile material of the electronic device. In addition, in some implementations, when the mechanical pressure is released, the cleaning pad may at least partially reabsorb the cleaning agent, along with the contaminants. As noted above, a cleaning pad may be left on the device for periods longer than required for the cleaning to occur, including periods of time extending over days or weeks.

In FIG. 4D, the second pad 460 is removed from the device. In some implementations, the removal can occur by first pulling up or tugging a portion of the pad such as an edge or a corner, and then peeling the rest of the pad away from the device. Thus, in one implementation, the pad can be resilient enough to withstand the pulling force without tearing, ripping, or otherwise leaving behind any residual mark.

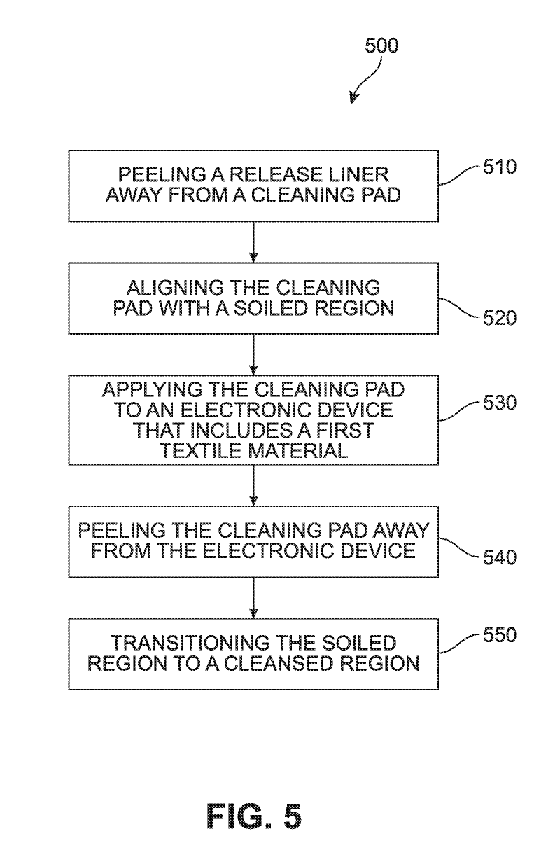

Referring now to FIG. 5, a flow chart 500 presenting an implementation of a method of cleaning an electronic device is shown. As shown in FIG. 5, a first step 510 includes peeling a release liner away from a lower surface of a cleaning pad, and a second step 520 includes aligning the cleaning pad with a soiled region of the electronic device. A third step 530 includes applying or affixing the cleaning pad to a portion of a surface of the electronic device that corresponds to the soiled region, where the soiled region includes a first textile material. In a fourth step 540, the cleaning pad is peeled away from the electronic device, and in a fifth step 550 the soiled region is transitioned to a cleansed region that is substantially free of contaminants.

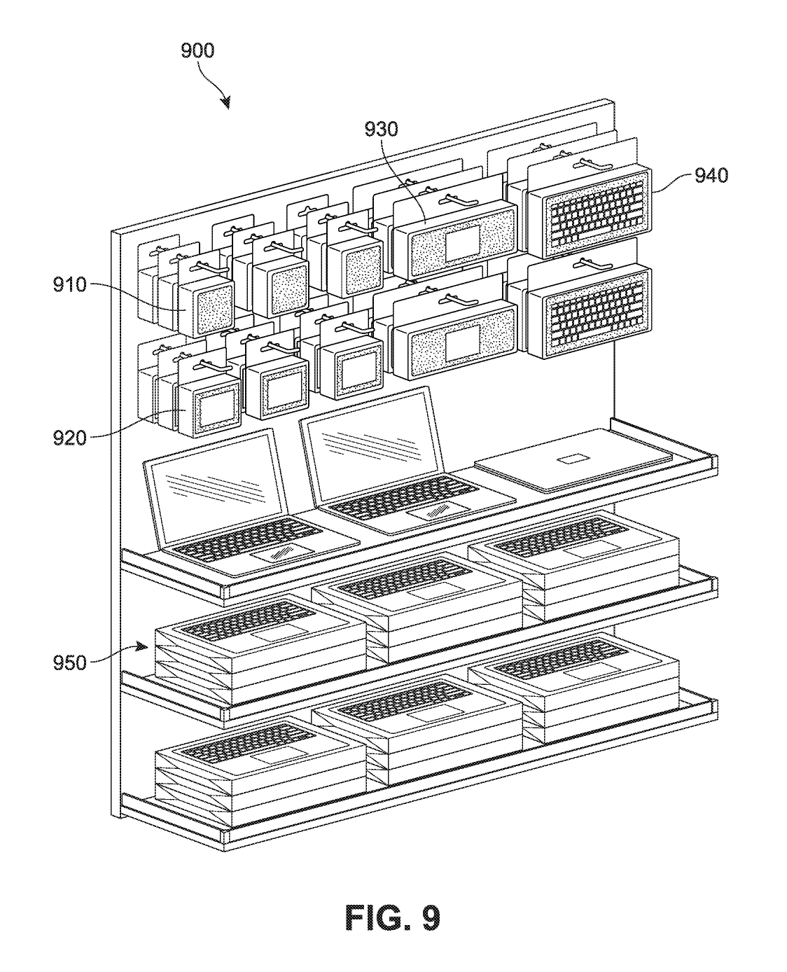

In other implementations, additional steps may be included. For example, as will be described further below with respect to FIG. 9, the method can also involve selecting a cleaning pad from a plurality of cleaning pads that optimally corresponds to a form factor of the soiled region and/or selecting a cleaning pad from a plurality of cleaning pads that includes a cleaning agent specifically configured to clean the first textile material. In another example, the method may include leaving the cleaning pad on the electronic device for a period ranging between 1 hour and 24 hours. In some cases, the method may include applying mechanical pressure (Z-direction force) to a backer layer of the cleaning pad while the cleaning pad is disposed on the textile surface of the electronic device. In another example, as will be discussed below with respect to FIG. 7, the method can include removing an outer strip from the cleaning pad, thereby activating a thermal layer of the cleaning pad and increasing a temperature of the cleaning pad, and/or rubbing an upper surface of the cleaning pad while the cleaning pad is applied to the electronic device, thereby activating a thermal layer of the cleaning pad and increasing a temperature of the cleaning pad. In addition, in some implementations, the method includes wiping the cleansed region to remove excess residue.

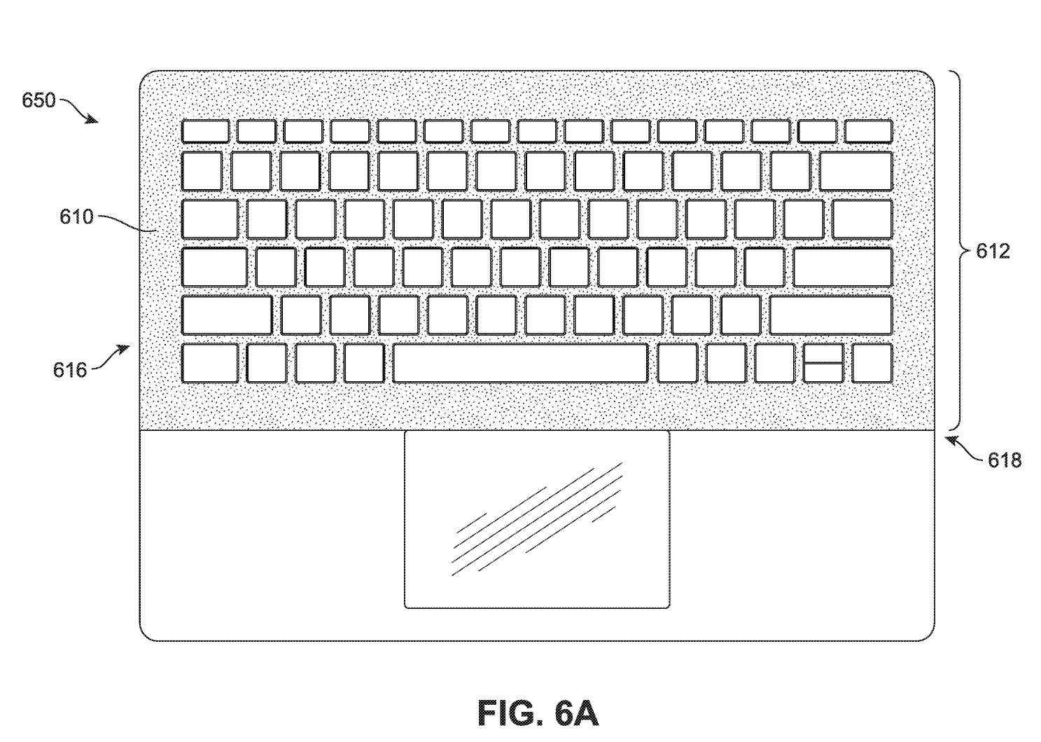

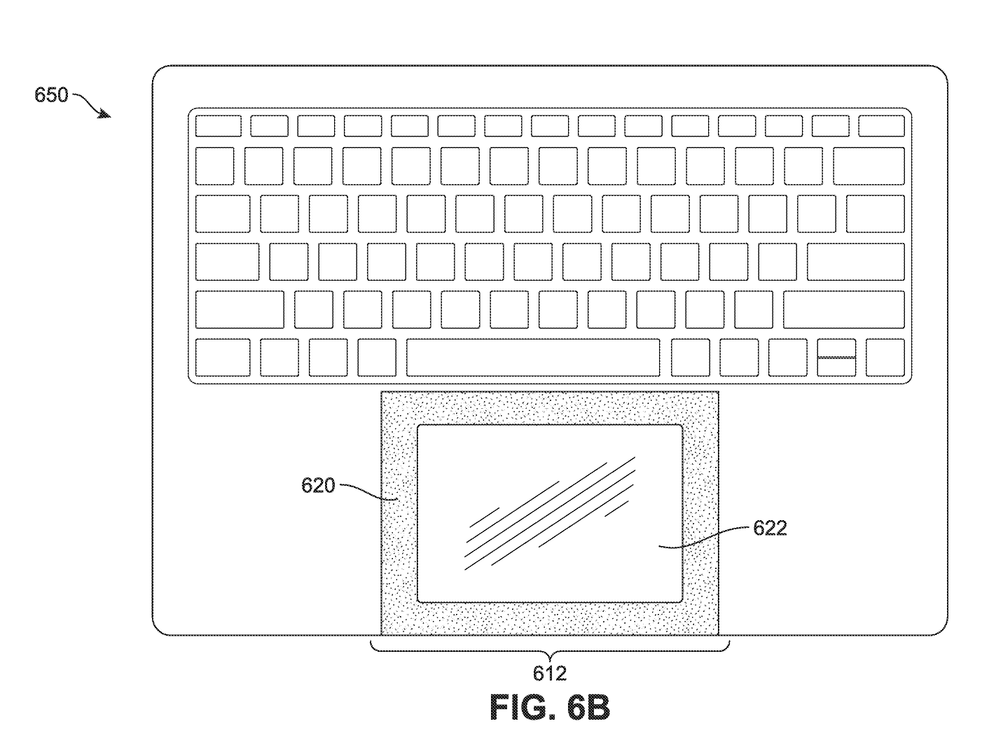

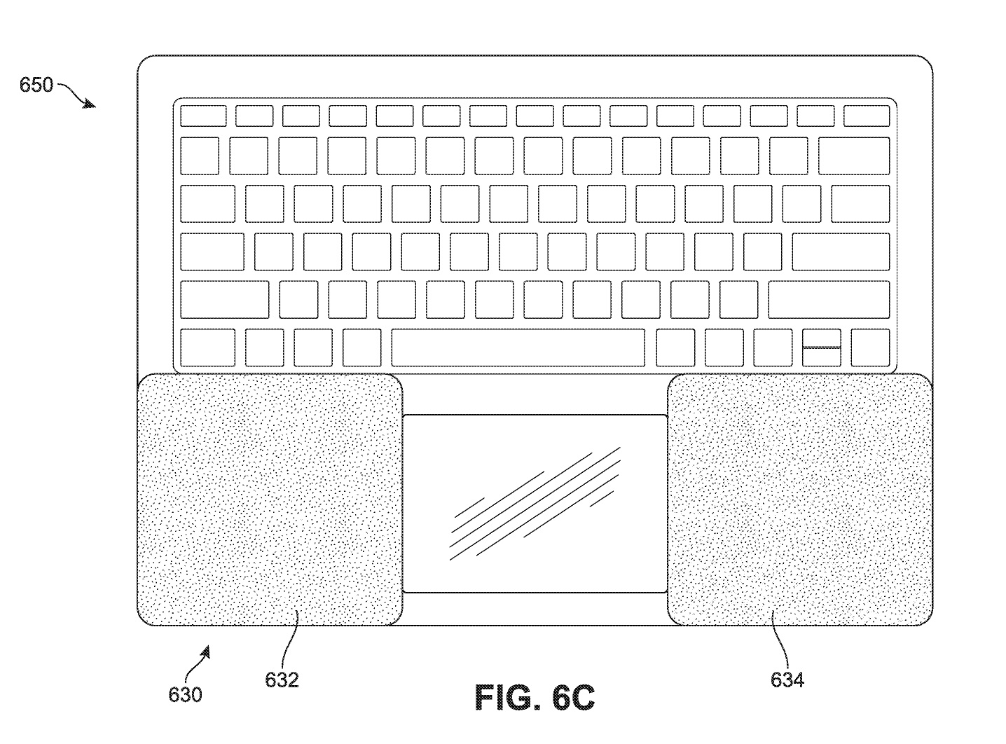

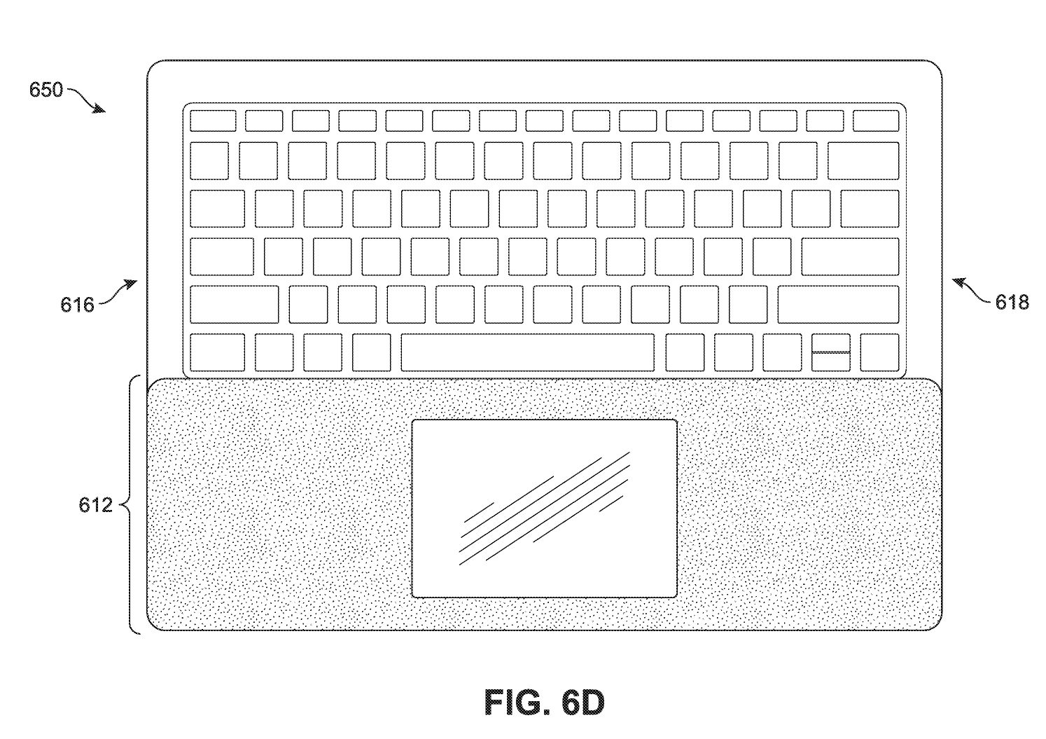

Electronic devices can vary widely in shape, size, dimensions, and specific aspects otherwise referred to as a device's form factor. In different implementations, the cleaning pad described herein can be sized and dimensioned to tailor the cleaning experience to specific devices as well as specific regions of a device. In other words, the cleaning pad can be customized for a particular device type (e.g., keyboards, cameras, mice, whiteboards, etc.) or specific commercial embodiment (e.g., Microsoft Surface®, Apple iPad®, Samsung Notebook®, Google Pixelbook®, Asus Chromebook Lenovo Yoga®, HP Spectre®, Asus ZenBook Flip®, and a wide range of other commercial electrical products beyond computing devices). Thus, the user may be able to select a particular cleaning pad that best aligns with the soiled region. Some examples of this are presented in FIGS. 6A-6D.

Previously, in FIG. 4A, the second pad 460 was shown as applied to a fabric-covered left side palm-rest portion of the device. In FIG. 6A, a larger, third cleaning pad (“third pad”) 610 is shown as applied across a substantial entirety of a keypad region 612 of a device 650. The third pad 610 includes a plurality of apertures 614 sized and aligned to correspond to each key of the keypad device. The apertures can vary in shape and size to conform with or accommodate the specific placement, shape, and size of the keys (or other elements) for a particular device. In some implementations, the apertures can have a substantially round, square, oblong, rectangular, triangular, polygonal, a rounded polygonal, or other regular or irregular shape. Furthermore, two apertures can differ in size and shape.

Thus, the material of the third pad can surround each key and/or allow access to the input buttons adjacent to or near the soiled region. A user who has perhaps found dirt or contaminants in the areas around the keys can apply or affix this type of pad to the device, using the steps described above with respect to FIG. 5. In this case, the cleaning pad extends from a first end 616 to a second end 618 of the device 650. In one implementation, the cleaning pad may include regions that are curved, contoured, bent, ridged, or textured to better fit, surround, encapsulate, or otherwise cover a portion of a specific device's form factor. For example, in FIG. 2, the first pad includes a curved portion 600 configured to wrap around or extend along a peripheral edge of a device. The third pad 610 can include one, two, or three curved regions that, when disposed on the designated device, can each extend over the plane of the keypad and along the peripheral outer edges of the device. Such regions can also facilitate the user's ability to identify the appropriate placement or use of the pad on a device.

FIG. 6B illustrates another example of a cleaning pad designed to correspond to a different region of the device 650. A fourth cleaning pad (“fourth pad”) 620 that is smaller than the third pad 610 is shown as applied around a trackpad region 622 of device 650. The fourth pad 620 includes a single aperture 622 that is sized and aligned to correspond to the shape and size of the trackpad while continuing to allow normal access to the trackpad. Thus, the material comprising the fourth pad can surround the trackpad while maintaining contact with the soiled region. A user who has perhaps found stains or contaminants in the area around the trackpad can apply or affix this type of pad to the device, using the steps described above with respect to FIGS. 4A-4D.

FIG. 6C depicts a set of cleaning pads (“pad set”) 630 designed to correspond to regions of the device 650 that may be more frequently soiled as a result of regular contact with a user. The pad set 630 includes a first pad 632 and a second pad 634. In some implementations, the first pad 632 and/or second pad 634 can be substantially similar to the first pad 260 of FIG. 2 and/or the second pad 460 of FIGS. 4A-4D. These pads do not include apertures and correspond generally to the left-side palm rest and the right-side palm rest of the device. Users often rest their hands on the device which may not always be clean. Thus, oils, dirt, and other contaminants can be regularly transferred to the palm rests during use of the device. Cleaning pads such as the first pad 632 and second pad 634 provide an easy, reliable, low-cost, and effective means of removing these stains, and can also serve to protect these regions from additional stains.

In FIG. 6D, a sixth cleaning pad (“sixth pad”) 640 is shown as applied across a lower region 642 of the device 650. As an example, the sixth pad 640 can include features similar to that of the fourth pad 620 of FIG. 6A as well as the first pad 632 and second pad 634 of FIG. 6C. Thus, in some implementations, the cleaning pad can be used to remove contaminants or stains across the palm-rest areas as well as the around the trackpad in a single application. In other implementations, the cleaning pads can include other shapes and sizes that are designed to correspond to specific regions of a particular product or model electronic device. A cleaning pad can, for example, have a substantially round, square, oblong, rectangular, triangular, polygonal, a rounded polygonal, or other regular or irregular shape. In some cases, the cleaning pad may be thumb-sized or include a single elongated strip. A user can then select the cleaning pad that is best suited for their device and stain type.

In different implementations, the cleaning pads described herein can include provisions for enhancing the ability of the cleaning agent to remove or cleanse a region of an electronic device. For example, in some implementations, the pads may include provisions for warming, heating, or otherwise increasing the temperature of the pad.

In some cases, cleaning agents can comprise chemical reactions that occur faster or more effectively at temperatures higher than room temperature. In other words, thermal energy can significantly improve the ability of a cleaning agent to remove stains, dirt, and residue on an outer surface of an electronic device. Thus, in some implementations, the pads described herein may include an additional layer or component configured to provide thermal energy to the cleaning apparatus when the sheet or pad is applied to the device. In some implementations, the inclusion of a thermal layer can reduce the time needed to clean the soiled region(s) of an electronic device.

One example is provided with respect to FIG. 7, where a seventh cleaning pad (“seventh pad”) 710 is illustrated as applied to the device 650, along with an enlarged isometric cutaway view 750 of the seventh pad 710. In this implementation, the seventh pad 710 includes a first portion 712 and a second portion 716, where the first portion 712 collectively corresponds to the backer layer, the carrier layer, and the cleaning agent (see FIG. 1), and the second portion 714 corresponds to a thermal energy substance or component layer disposed above the first portion 712. For purposes of clarity, an optional release 714 liner is also depicted, removed and separated from the seventh pad 710. It can be understood that when the seventh pad 710 is initially provided to a consumer, the cleaning pad can include a release liner, such as release liner 714. In general, the release liner 714 will be disposed below both the first portion 712 and the second portion 716.

Once the release liner 714 is removed and the activation area of the pad has been exposed, the pad can be affixed to the electronic device, allowing the cleaning agent to be in direct contact with the selected region, while the thermal layer remains attached to the first portion 712. However, in other implementations, the thermal layer may be configured to be removable. For example, after the thermal layer has been used to apply heat to the cleaning pad it may be removed. Though not expressly described in FIG. 7, it should be understood that all features, components, characteristics, and properties discussed with respect to FIGS. 1-6, 8, and 9 may be associated with the seventh pad 710, and all implementations of the cleaning pad described herein may include a thermal layer.

In different implementations, the thermal energy layer can include a wide range of heat-generating materials. For example, the second portion 716 can include air activated warmers or heat-generating packets that contain an oxidizing chemistry in a single compartment or sack. Generally, the rate of chemical reaction, and hence heat generation, may be controlled by the amount of oxygen which is allowed to reach the packet. This may be achieved by providing at least one surface of the warmer with a specific oxygen permeability while all other surfaces are impermeable. In one example, the upper surface of a cleaning pad may include an outer strip or removable covering that when peeled or pulled off activates the thermal layer. In some implementations, the warmer associated with the third layer 716 can contain cellulose, iron, water, activated carbon, vermiculite, and/or salt and thereby produce heat from an exothermic oxidation of iron when exposed to air.

Such materials can typically emit heat for 1 to 10 hours. Salt is often added to catalyze the process. In another example, the third layer can be associated with a type of battery operated warmer that uses electrically resistive heating devices to convert electrical energy in the battery. Rechargeable electronic warmers can also be fastened or attached to the outer surface of the implementations of the cleaning pads described earlier. Thus, in some implementations, the pads can include provisions for secure contact with such warmers, such as hook-and-loop fasteners, adhesives, buttons, or other releasable connectors.

In other implementations, the warmer can include an insert packet that can be warmed in a microwave or hot water, where the insert packet contains phase change materials. The insert packet can be disposed within a pocket or sleeve formed within the second portion 716. After heating, the insert packet can be slid into the corresponding pocket in the cleaning pad. In one implementation, a visible temperature indicator may be included on the warmer, so the consumer is notified as to its thermal state. In another implementation, the thermal layer may be activated by the application of friction against the surface of the third layer. For example, a user may gently rub or exert mechanical pressure against the cleaning pad after placement of the pad on the soiled region. As the pressure increases, thermal energy is released and the cleaning agent is activated.

It should be understood that the implementations described herein will generate heat only to the extent needed for the enhancement or activation of the cleaning agent, and that the level of heat will remain below a temperature that could potentially adversely affect the operation of an electronic device. In one implementation, a thermal layer can be configured to increase the temperature applied to the cleaning agent to between approximately 104-115° F. (40-46° C.). In some implementations, enzymes found in the cleaning agent can be understood to be optimized at temperatures approaching 113° F.

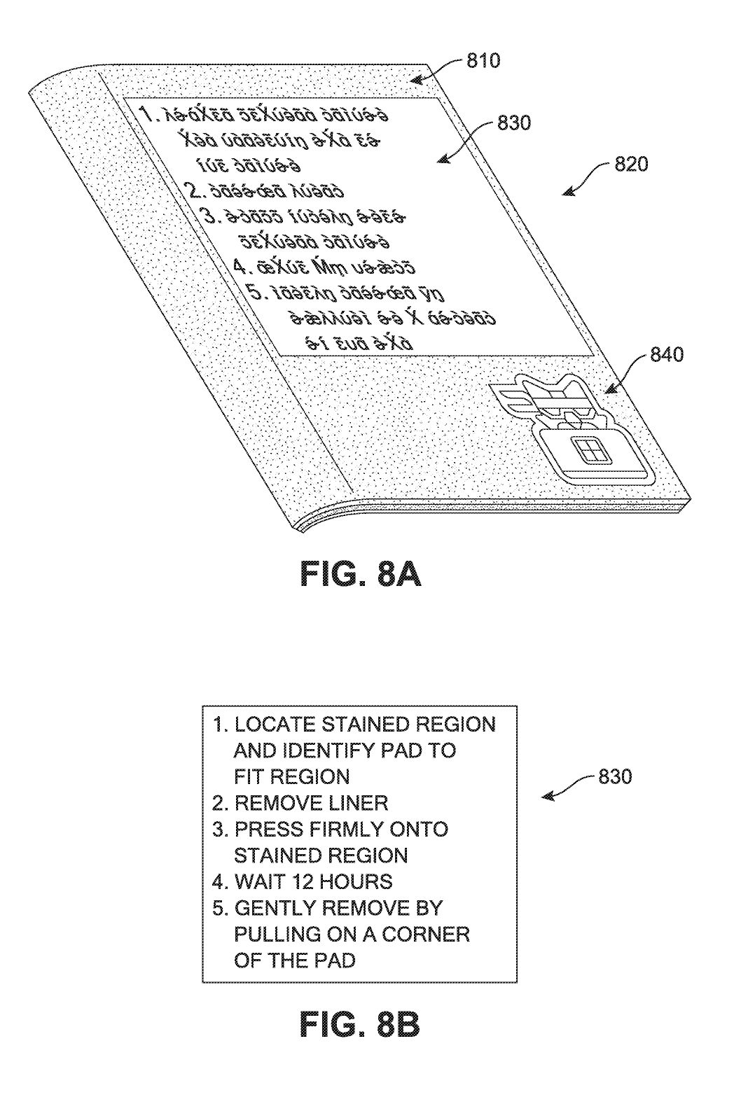

In different implementations, cleaning pads as described herein may also include provisions for displaying information or graphic designs, including visual and textual content. For example, referring to FIG. 8A, an outwardly-facing surface 810 of an eighth cleaning pad (“eighth pad”) 820 can include text, symbols, numbers, or any other designs. In some implementations, the surface 810 corresponds to the upper surface of the backer layer (see FIG. 3) or any other outwardly facing surface of the cleaning pad. In one implementation, information may be printed onto the backer or may comprise a separate layer that is attached to the surface 810. In some implementations, the pad can include advertising or promotional tools for a business. For example, some implementations can include branding, images, text, or other information. In one implementation the cleaning pad may be shaped to have an appearance of, for example, a corporate logo, a smartphone, a food item, or other symbol.

In FIG. 8A, the surface 810 of the eighth pad 820 includes a block of text 830 and an image 840. In different implementations, the text and/or images can be selected by a user or uploaded to a cloud service for printing directly onto the cleaning pads, permitting users to add ‘flair’ or personalization to their electronic devices while also cleaning, maintaining, or otherwise protecting the device appearance. In FIG. 8B, an example of some text that may be included on a cleaning pad is shown in the form of instructions for use. These instructions can vary across different cleaning pads, and can include directions as to the period of time needed for application, the orientation of the pad, the type of mechanical pressure to be applied, the manner of removal of the cleaning pad, the disposal of the cleaning pad, the use of a wipe, the means of removing the liner, and other usage information.

Furthermore, the cleaning pads can be modified or customized to provide different levels of functionality and appearance. As one example, a thickness of the cleaning pad can be increased to provide a softer feel or a more deformable, elastic outer surface. In other words, an additional layer of foam or cushioning material can be added to a cleaning pad to increase the comfort of a user when resting a hand or other body portion on the pad. In addition, the material of the surface 810 can be soft, textured, hard, or smooth, depending on the preference of a user. Similarly, the color of the surface 810 can vary widely, and can be selected by a consumer to align with their preference. In some cases, the color can indicate the type of cleaning agent or commercial product (electronic device) that the cleaning pad is configured for use with.

As noted earlier, in different implementations, the cleaning pads described herein may be provided in varying shapes, sizes, sets, and/or be configured for particular electronic devices. In FIG. 9, for purposes of illustration, a retail display 900 is shown that includes several sets of cleaning pads. For example, the retail display 900 includes a first package 910, a second package 920, a third package 930, and a fourth package 940, displayed in this case conveniently adjacent to a plurality of electronic devices 950. The first package 910 includes a multi-pack of cleaning pads that are similar to the cleaning pad shown in FIG. 2. The second package 920 includes a multi-pack of cleaning pads that are similar to the cleaning pads shown in FIG. 6B. The third package 930 includes a multi-pack of cleaning pads that are similar to the cleaning pad shown in FIG. 6D. The fourth package 940 includes a multi-pack of cleaning pads that are similar to the cleaning pad shown in FIG. 6A.

In addition, in some implementations, a package may include a variety pack, in which an assortment of cleaning pads of varying sizes and shapes for an electronic device are included and packaged for sale. Thus, one pack may include cleaning pads with a first surface area as well as cleaning pads with a second, different surface area. In addition, some cleaning pads may be configured for use with a particular type of contaminant or stain, while other cleaning pads are designed for a different type of contaminant or stain. Furthermore, some of the cleaning pads can be configured for use with a specific commercial product or device type. In another implementation, one or more packages may include wipes for use following the removal of the cleaning pad, such as but not limited to ISA-based wipes or microfiber cloth.

For purposes of reference, the following section presents a glossary of some terms used in the present application. It should be understood that these terms also encompass the descriptions provided above with respect to FIGS. 1-9.

A controlled release refers to the mechanism by which a cleaning pad releases the cleaning agent mainly in a discrete area in response to mechanical pressure being applied to the article in that area. Mechanical pressure refers to pressure in the Z-direction (up-down) impinging on the cleaning pad. Such pressure may be applied by hand, or any other mechanical stamping-type components. A discrete area refers to the release of the cleaning agent mainly from that area of the pad where the pressure is applied, rather than across the entire surface of the pad, thereby directing the cleaning agent primarily to the stained area.

A carrier generally refers to an absorbent carrier substrate. The substrate can be in any desired form, such as powders, flakes, shreds, and/or an integral pad or sheet which substantially maintains its structural integrity throughout the cleaning process. The pads or sheets can be prepared, for example, using well-known methods for manufacturing non-woven and woven cloth, paper towels, fibrous batts, or other textiles, using materials such as wood pulp, cotton, rayon, polyester fibers, and mixtures thereof. The pads may also be prepared from natural or synthetic sponges, foams, and other artificial fibers or fabrics. The carriers are selected to remain safe and effective under the intended operating conditions of the cleaning process. The carriers are not flammable during the cleaning process, nor do they deleteriously interact with the cleaning agent or the textile cover or other components of the electronic device. The carriers used herein may be non-linting, or resistant to shedding of visible fibers or microfibers.

As described above, the carrier will include a size which provides sufficient surface area that effective contact between the surface of the carrier and the surface of the fabrics being treated may be achieved. However, the size of the carrier will generally not be so large as to be unwieldy for the consumer. In some implementations, the dimensions of the carrier should provide a macroscopic surface area (both sides of the carrier) of at least about 360 cm², preferably in the range from about 360 cm² to about 3000 cm². As one example, a generally rectangular carrier may have the dimensions (X-direction) ranging between about 20 cm to about 35 cm, and (Y-direction) ranging between about 18 cm to about 45 cm. It should be noted that two or more smaller cleaning pad units can be used when a larger surface area than the pad is desired for cleaning.

Furthermore, the carrier can be configured or arranged to receive, hold, or otherwise contain a sufficient amount of the cleaning agent to be effective for its intended purpose. The capacity of the carrier for such agents will therefore vary according to the intended usage. For example, articles such as cleaning pads or sheets which are intended for a single use will require less capacity than cleaning pads or sheets which are intended for multiple uses. For a given type of carrier the capacity for the cleaning or refreshment composition will vary mainly with the thickness or “caliper” (Z-direction; dry basis) of the cleaning sheet or pad. For purposes of illustration, typical single-use polyester sheets used herein can have a thickness in the range from about 0.02 mm to about 0.8 mm and multi-use polyester cleaning pads can have a thickness in the range from about 0.2 mm to about 2.0 mm. Open-cell sponge sheets will range in thickness from about 0.05 mm to about 1.5 mm. These dimensions are provided as examples only and are not intended to be limiting. In different implementations, the carrier layer can include a binderless or low binder, hydroentangled absorbent material, such as materials composes of one or more of cellulosic, rayon, polyester and optional bicomponent fibers.

In addition, an effective amount refers to an amount of cleaning agent sufficient to provide the phase-stable composition capable of removing stains. The use of the term cleaning refers to the removal of soils and stains from textiles. Contact with stained areas refers to contact of the cleaning agent that occurs upon application of the pad during the treatment. The contact can be a result of a force which is directed substantially downward (in the Z-direction), substantially perpendicular to the surface of the stain, or a side-to-side scrubbing motion in the X- and Y-directions. In cases where Alcantara or similar fabrics are being cleaned, it may be helpful to avoid sharp pushing, crushing, or twisting forces on the pad, in order to minimize fabric damage or “wear”. Generally, mechanical pressure can help agitate the contaminant particles and help with the absorption of the stain by the cleaning pad.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A cleaning tool for use with electronic devices, the cleaning tool comprising:
a carrier layer including an absorbent substrate;
a cleaning agent stored by the carrier layer;
a backer layer disposed above the carrier layer;
a release liner disposed below the carrier layer;
an activation area disposed between the release liner and the carrier layer, the activation area configured to be removably affixed to a textile-based surface of an electronic device, thereby exposing the textile-based surface to the cleaning agent and cleaning the textile-based surface.

2. The cleaning tool of claim 1, wherein the backer layer provides structural support to the cleaning tool.

3. The cleaning tool of claim 1, wherein the cleaning agent is impregnated in the carrier layer.

4. The cleaning tool of claim 1, further comprising a thermal layer configured to increase a temperature of the cleaning tool.

5. The cleaning tool of claim 1, wherein the cleaning agent includes a surfactant and enzymes.

6. A method of cleaning an electronic device, the method comprising:
peeling a release liner away from a lower surface of a cleaning pad;
aligning the cleaning pad with a soiled region of the electronic device;
applying the cleaning pad to a portion of a surface of the electronic device that corresponds to the soiled region, the soiled region including a first textile material;
peeling the cleaning pad away from the electronic device; and
thereby transitioning the soiled region to a cleansed region that is substantially free of contaminants.

7. The method of claim 6, further comprising selecting a cleaning pad from a plurality of cleaning pads that optimally corresponds to a form factor of the soiled region.

8. The method of claim 6, further comprising selecting a cleaning pad from a plurality of cleaning pads that includes a cleaning agent configured to clean the first textile material.

9. The method of claim 6, further comprising leaving the cleaning pad on the electronic device for a period ranging between 1 hour and 24 hours.

10. The method of claim 6, further comprising applying pressure to a backer layer of the cleaning pad while the cleaning pad is applied to the electronic device.

11. The method of claim 6, further comprising applying removing an outer strip from the cleaning pad, thereby activating a thermal layer of the cleaning pad and increasing a temperature of the cleaning pad.

12. The method of claim 6, further comprising rubbing an upper surface of the cleaning pad while the cleaning pad is applied to the electronic device, thereby activating a thermal layer of the cleaning pad and increasing a temperature of the cleaning pad.

13. The method of claim 6, further comprising wiping the cleansed region to remove excess residue.

14. A kit of parts for cleaning electronic devices, the kit of parts comprising:
a first cleaning pad, the first cleaning pad including:
a carrier layer;
a cleaning agent, the cleaning agent being stored by the carrier layer; and
the cleaning agent being configured to clean a surface of an electronic device that includes a first type of textile material.

15. The kit of parts of claim 14, further comprising:
a second cleaning pad, the second cleaning pad including:
a carrier layer;
a cleaning agent, the cleaning agent being stored by the carrier layer; and
the cleaning agent being configured to clean a surface of an electronic device that includes a second type of textile material, the second type being different than the first type.

16. The kit of parts of claim 15, the first cleaning pad further comprising a backer layer disposed above the carrier layer.

17. The kit of parts of claim 15, the first cleaning pad further comprising a release liner, the release liner being disposed below the carrier layer.

18. The kit of parts of claim 15, further comprising a second cleaning pad, wherein the first cleaning pad has a larger surface area than the second cleaning pad.

19. The kit of parts of claim 14, further comprising a second cleaning pad, wherein the first cleaning pad has a first shape and the second cleaning pad has a second shape that is different than the first shape.

20. The kit of parts of claim 16, wherein the backer layer includes a graphic design.
